(19) United States
(12) Patent Application Publication
(10) Pub. No.: US 2026/0132614 A1
(43) Pub. Date: May 14, 2026

(54) LINKABLE MODULAR ACCESS CONTROL (MAC) UNITS

(71) Applicant: PORTABLE SOLUTIONS GROUP, LLC, Wurtland, KY (US)

(72) Inventor: Robert Slagel, Wurtland, KY (US)

(73) Assignee: PORTABLE SOLUTIONS GROUP, LLC, Wurtland, KY (US)

(21) Appl. No.: 19/382,794

(22) Filed: Nov. 7, 2025

Related U.S. Application Data
(60) Provisional application No. 63/718,184, filed on Nov. 8, 2024.

(51) Int. Cl. E04B 1/348; E06B 11/08

(52) U.S. Cl. CPC E04B 1/34869; E06B 11/08

(57) ABSTRACT

A modular access control system comprising a plurality of modular access control units, each comprising an access control barrier within a structural enclosure configured to control passage from a non-secure side to a secure side, a mechanical linkage configured to mechanically connect to an adjacent modular access control unit, and an electrical connection configured to electrically connect to the adjacent unit. The mechanical linkage comprises threaded connection tabs configured to receive all-thread bolts for mechanical connection, with bolts secured with jam nuts positioned on both sides. The electrical connection comprises an electrical panel on the secure side and an exterior junction box electrically connected to the panel. The system enables multiple units to be mechanically and electrically linked together to create scalable security portal installations deployable and reconfigurable as needed.

### CROSS-REFERENCE TO RELATED APPLICATIONS

This application claims priority to U.S. Provisional Ser. No. 63/718,184, titled “Linkable Modular Access Control (MAC) Units,” filed Nov. 8, 2024, which is hereby incorporated by reference in its entirety.

### FIELD OF INVENTION

The present disclosure relates to modular access control systems, and more particularly to linkable modular access control (MAC) units that can be mechanically and electrically connected together to create scalable security portal installations.

### BACKGROUND

Access control systems are desired for secure areas such as construction sites and industrial facilities to prohibit unauthorized use by outsiders. Applicant has developed and patented different types of access control systems. See, e.g., U.S. Pat. Nos. 7,762,025; 7,823,338; 8,015,754; 8,671,624; 9,051,748; 9,404,278; 10,138,642; 10,626,629; and 11,149,453. The access control systems include multiple access control units, each to control access to a particular facility.

However, conventional access control units (also referred to in short as units) face several technical limitations when multiple access control units are needed to accommodate higher traffic volumes or create multi-lane access points. Deploying separate, independent units can result in gaps in security coverage, inconsistent access control policies, and increased complexity in system management and data collection. Additionally, independent units may require separate power connections and individual data collection systems, leading to increased installation costs and operational complexity.

Conventional access control units are not designed to accommodate the evolving needs of installations where different numbers of facilities may be required over time. Construction sites, industrial facilities, and event venues often experience fluctuating occupancy levels and changing security requirements that may necessitate scaling up or down the number of access control units. Traditional fixed installations cannot be easily reconfigured when additional facilities are added to a site or when temporary expansions are needed to handle increased traffic flow.

As such, a significant improvement upon access control units is therefore desired.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a modular access control system is provided. The modular access control system comprises a plurality of modular access control units. Each modular access control unit comprises an access control barrier disposed within a structural enclosure and configured to control passage from a non-secure side to a secure side. Each modular access control unit comprises a mechanical linkage configured to mechanically connect to an adjacent modular access control unit. Each modular access control unit comprises an electrical connection configured to electrically connect to the adjacent modular access control unit.

According to another aspect of the present disclosure, a modular access control system is provided. The modular access control system comprises a plurality of modular access control units positioned adjacent to each other. Each modular access control unit comprises a structural enclosure and an access control barrier. The modular access control system comprises mechanical linking hardware connecting the plurality of modular access control units together. The mechanical linking hardware comprises threaded fasteners passing through aligned connection points on adjacent modular access control units. The modular access control system comprises electrical connections between the plurality of modular access control units configured to distribute power from a single power source to multiple modular access control units.

According to another aspect of the present disclosure, a method of deploying a scalable access control system is provided. The method comprises positioning a first modular access control unit at a desired location. The method comprises positioning a second modular access control unit adjacent to the first modular access control unit. The method comprises mechanically connecting the first modular access control unit to the second modular access control unit using connection hardware. The method comprises electrically connecting the first modular access control unit to the second modular access control unit to enable power sharing.

The modular access control system provides scalable security solutions for construction sites where temporary access control is needed to manage worker entry and exit while maintaining site security. The system enables construction site managers to deploy multiple linked units to accommodate varying workforce sizes and changing site configurations as construction progresses. For industrial facilities, the modular access control system provides flexible security checkpoints that can be reconfigured to match operational requirements and facility expansions. The linked units allow industrial facility operators to create multi-lane access points for shift changes while maintaining centralized control and data collection. At concerts and events, for example, the modular access control system enables rapid deployment of scalable entry portals that can handle high-volume ticket scanning and crowd management while providing real-time attendance data collection across multiple linked access points.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates an isometric view of a modular access control system from a secure side, according to aspects of the present disclosure.

FIG. 1B illustrates a detailed view of a mechanical linkage between adjacent modular access control units, according to aspects of the present disclosure.

FIG. 1C illustrates a plan view of the modular access control system of FIG. 1A from the secure side, according to aspects of the present disclosure.

FIG. 2 illustrates an electrical wiring diagram for a modular access control unit, according to aspects of the present disclosure.

FIG. 3A illustrates an isometric view of a modular access control unit with a roof removed, according to aspects of the present disclosure.

FIG. 3B illustrates another isometric view of the modular access control unit of FIG. 3A showing internal components, according to aspects of the present disclosure.

FIG. 3C illustrates an orthogonal top-down view of internal components of a modular access control unit, according to aspects of the present disclosure.

FIG. 4 illustrates an isometric view of a modular access control system comprising a guard booth, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Embodiments disclosed herein describe a modular access control system that may include multiple modular access control units linked together in accordance with the disclosed principles. Any number of modular access control units may be added and removed to cater to the evolving need for any secure site. The modular access control units may include mechanical linkages, electrical connections, and wired/wireless data connections. These linkages and connections allow for on-site configuration and reconfiguration of the access control system. Additionally, one or more guard booths may be installed as a part of the modular access control system.

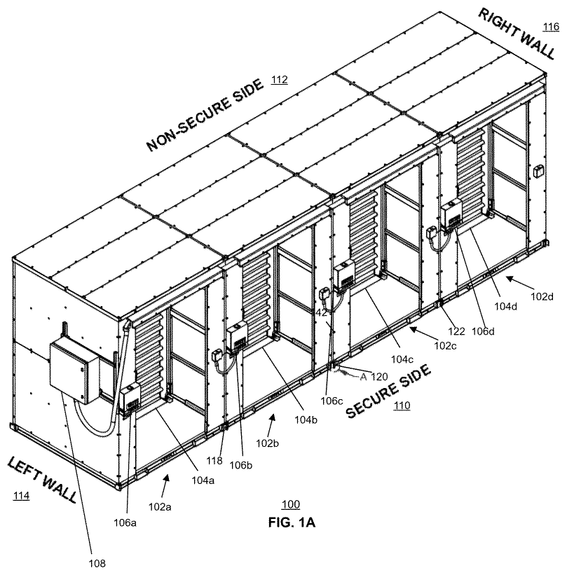

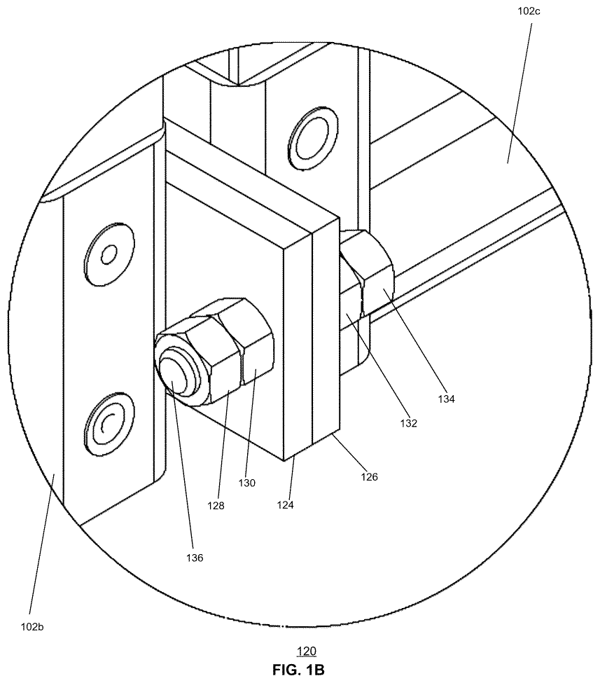

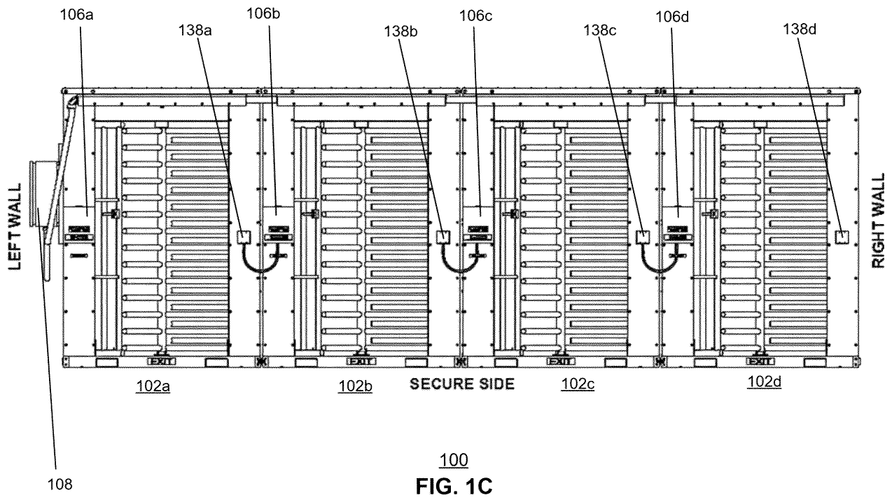

FIG. 1A shows an isometric view of an example modular access control system 100, based on the principles disclosed herein. The modular access control system 100 is shown from a secure side 110 point of view. As shown, the modular access control system 100 includes modular access control units 102a, 102b, 102c, 102d (collectively referred to as modular access control units 102 and commonly referred to as a modular access control unit 102) that are mechanically connected and have a common electrical and electronic connection in accordance with the disclosed principles.

Each of the modular access control units 102a, 102b, 102c, 102d includes an access control door 104a (for modular access control unit 102a), 104b (for modular access control unit 102b), 104c (for modular access control unit 102c), 104d (for modular access control unit 102d) (commonly referred to as an access control door 104 and collectively referred to as access control doors 104). Access control doors 104 may also be referred to as access control barriers. The access control door 104 may include any kind of gating or barrier that can be opened for authorized users. For instance, the access control door 103 may include an electrically activated turnstile (e.g., a full height turnstile), a rising gate, and/or any other type of barrier that can be selectively opened and closed.

Each of the modular access control units 102a, 102b, 102c, 102d includes an electrical panel 106a (for modular access control unit 102a), 106b (for modular access control unit 102b), 106c (for modular access control unit 102c), 106d (for modular access control unit 102d). The electrical panel 106 may provide power and/or electronic communication for the corresponding modular access control unit 102. All of the electrical panels 106 may be connected to a main panel 108 that may receive power from a power source and distribute the received power to the electrical panels 106.

The modular access control units 102a, 102b, 102c, 102d may be mechanically linked to each other using mechanical linkage 118 (mechanically linking access control units 102a, 102b), 120 (mechanically linking access control units 102b, 102c), 122 (mechanically linking access control units 102c, 102d). Additional details of an example mechanical linkage 120 is described with respect to FIG. 1B below.

The modular access control units 102 when connected to each other form the modular access control system 100. Although four modular access control units 102 are shown for illustration, any number of modular access control units 102 may be connected to each other. Within the modular access control system 100, a left wall 114 may include the main panel 108 (just as an example, the main panel 108 may be located at any point within the modular access control system 100 such as in the right wall 116).

The modular access control system 100 may receive power from any kind of power source. For example, the power may be an onsite power (e.g., connected to the main panel 108) and/or solar power. The modular access control system 100 may further be powered by AC or DC power. The modular access control system 100 may include integrated surge protection to protect all access control and data collection systems within the system 100.

The modular access control system 100 may include data collection system, which may be connected to a cloud/network (e.g., Internet). The data collection system may record and/or transfer identifying information of individuals who badged/utilized biometric sensor to activate the access control doors 104, data and time of the scan, the access control unit 102 the individual was badged into, whether the badge was accepted or denied, unlock a signal for the electronically controlled access control doors 104, and/or any other type of information.

The data collection may be facilitated by hardwired data connection between the access control units 102 via mechanically linked conduits between the raceways. Additionally or alternatively, there may be wireless communications between the individual access control units 120. The modular access control system 100 may further be wirelessly connected to a cloud service. The modular access control system 100 may further be integrated into any type of access control system in the market.

FIG. 1B illustrates a detailed view of the mechanical linkage 120 between modular access control unit 102b and modular access control unit 102c, based on the principles disclosed herein. The detailed view shows the mechanical linkage 120 from the secure side 110 point of view.

The mechanical linkage 120 comprises connection hardware that passes through aligned connection points on the structures of the adjacent modular access control units 102b, 102c. Specifically, a tab 124 is disposed on modular access control unit 102b, and another tab 126 is disposed on modular access control unit 102c. The tabs 124, 126 may include a strengthened structure that may be configured to absorb the stress of repeated coupling and uncoupling of the mechanical linkage 120. The tabs 124, 126 are positioned adjacent to each other when the modular access control units 102b, 102c are placed side by side.

To create and maintain the mechanical linkage 120, an all-thread bolt 136 passes through aligned holes in tab 124 and tab 126, providing the mechanical connection between the two modular access control units 102b, 102c. The all-thread bolt 136 may be secured using multiple nuts. Nut 128 and nut 130 are positioned on one side of the connection (i.e., on the side of modular access unit 102b), while nut 132 and nut 134 are positioned on the other side of the connection (i.e., on the side of the modular access control unit 102 c). The nuts 128,130, 132, 134 are threaded onto the all-thread bolt 136 and tightened to create a rigid mechanical connection that maintains alignment between modular access control unit 102b and modular access control unit 102c. In one or more embodiments, one or more of nuts 128,130, 132, 134 are lock nuts.

The mechanical linkage 120 provides structural rigidity to the connected modular access control units 102, preventing relative movement between adjacent units and ensuring proper alignment of the access control barriers 106 and other components within each modular access unit 102. The threaded connection using the all-thread bolt 136 allows for field assembly and disassembly of the modular access control system 100 without requiring specialized tools or permanent fastening methods. Therefore, any permutation of any number of modular access control units 102 may be realized as the need dynamically evolves.

It should however be understood that the mechanical linkage 120 is just an example and should not be considered limiting. The mechanical linkage may include other types of bolting system, latching system, external clamping system, and/or any other type of mechanical linkage. The mechanical linkage 120 generally allows for mechanical interlocking and self-aligning the units on uneven terrain. Such mechanical connection and alignment may be desired to protect and prevent damage to power and data connection systems.

FIG. 1C illustrates a plan view of the modular access control system 100 from the secure side, based on the principles disclosed herein. As shown, the modular access control system 100 comprises modular access control unit 102a, modular access control unit 102b, modular access control unit 102c, and modular access control unit 102d positioned adjacent to each other in a linear arrangement.

As further shown in FIG. 1C, each modular access control unit 102 includes an electrical panel 106 mounted on its right wall when viewed from the secure side. Specifically, electrical panel 106a is disposed on modular access control unit 102a, electrical panel 106b is disposed on modular access control unit 102b, electrical panel 106c is disposed on modular access control unit 102c, and electrical panel 106d is disposed on modular access control unit 102d. The electrical panels 106a, 106b, 106c, 106d are configured for power distribution within their respective modular access control units 102a, 102b, 102c, 102d. The main panel 108, as described above, is disposed on modular access control unit 102a and is configured to receive power from a site power source. The main panel 108 serves as the primary power distribution point for the modular access control system 100.

Junction box 138a is disposed on modular access control unit 102a, junction box 138b is disposed on modular access control unit 102b, junction box 138c is disposed on modular access control unit 102c, and junction box 138d is disposed on modular access control unit 102d. The junction boxes 138a, 138b, 138c, 138d (collectively referred to as junction boxes 138 and commonly referred to as a junction box 138) are positioned on the secure side of each modular access control unit 102 and provide connection points for electrical cables between adjacent units.

Electrical connections route between the junction boxes 138 and electrical panels 106 of adjacent modular access control units 102. Power flows from the main panel 108 through the junction boxes 138 to distribute electrical power throughout the modular access control system 100. The junction boxes 138 enable field connections to be made between adjacent modular access control units 102, allowing power to be shared from a single power source to multiple units. This configuration permits modular access control units 102 to be electrically linked together in various configurations without requiring separate power connections for each unit.

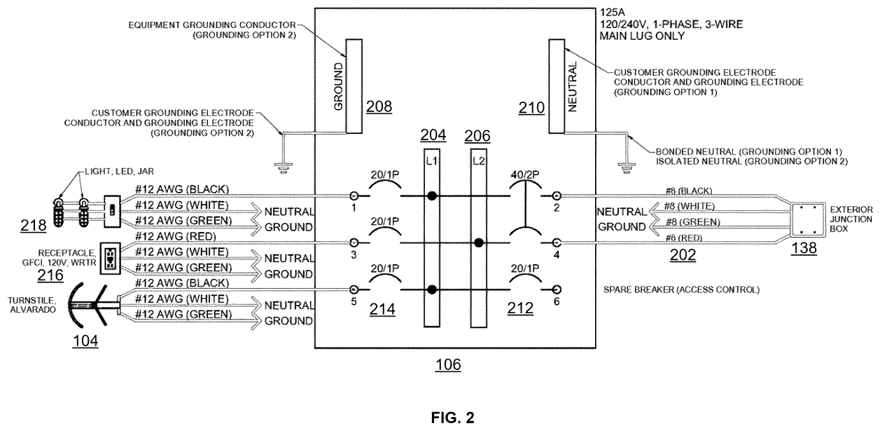

FIG. 2 illustrates an example electrical wiring diagram for a modular access control unit 102, showing the power distribution and electrical connections between components, based on the principles disclosed herein. The diagram depicts the electrical configuration for a 125 A, 120/240V, 1-phase, 3-wire main lug only system, which, however, should be treated as a non-limiting example only.

The electrical panel 106 receives power from the junction box 138 through electrical connections 202 and circuit breakers 212; and serves as the power distribution point for the corresponding modular access unit 102. As shown, hot wire 204 provides power to the access control door 104 (e.g., a turnstile) and the lighting 218 (e.g., LED, jar lamp, and/or any other type of lighting) through the corresponding circuit breakers 214. Additionally, hot wire 206 provides power to the outlet 216 (e.g., GFCI outlet) through a corresponding circuit breaker 214. In the illustrated embodiment, circuit breakers 212 are configured as 20/1P breakers, while circuit breakers 214 are configured as 40/2P breakers, however, these are just examples. Junction box 138 is positioned to facilitate electrical connections 202 between adjacent modular access control units when multiple units are linked together.

FIG. 2 shows two grounding options: Grounding Option 1 utilizes a customer grounding electrode conductor and grounding electrode with a bonded neutral, while Grounding Option 2 employs an equipment grounding conductor with an isolated neutral. The wiring configuration supports the modular nature of the system, allowing electrical power to be shared across multiple connected units while maintaining proper circuit protection and grounding. The neutral 210 and ground 208 connections are maintained throughout the system to ensure safe operation and compliance with electrical codes.

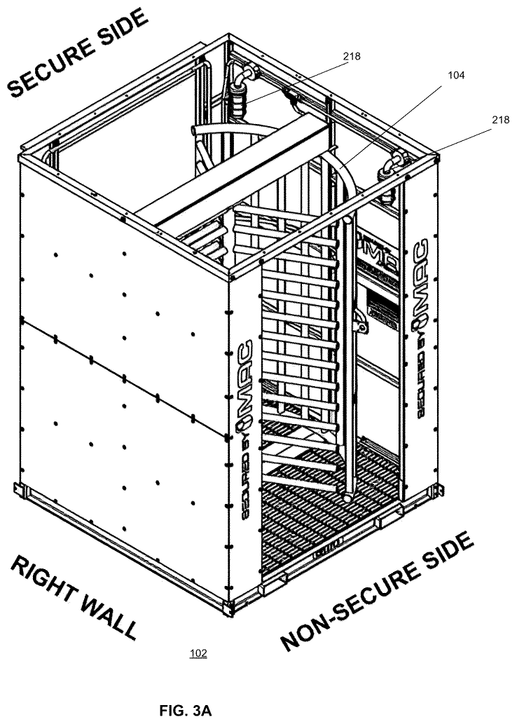

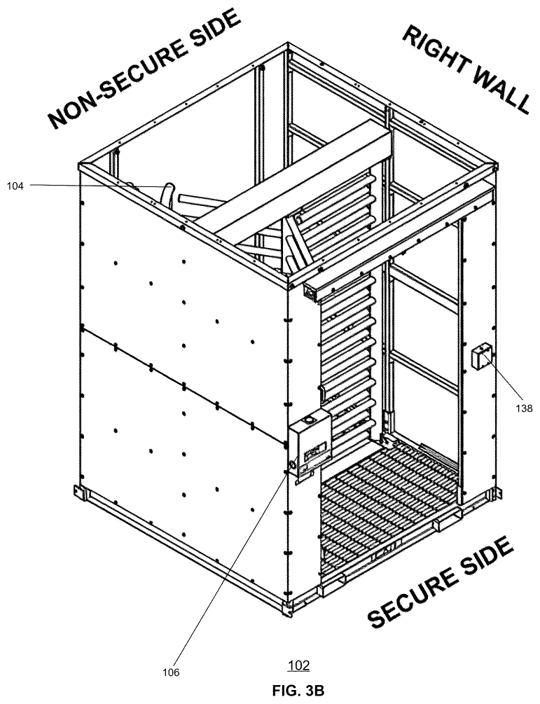

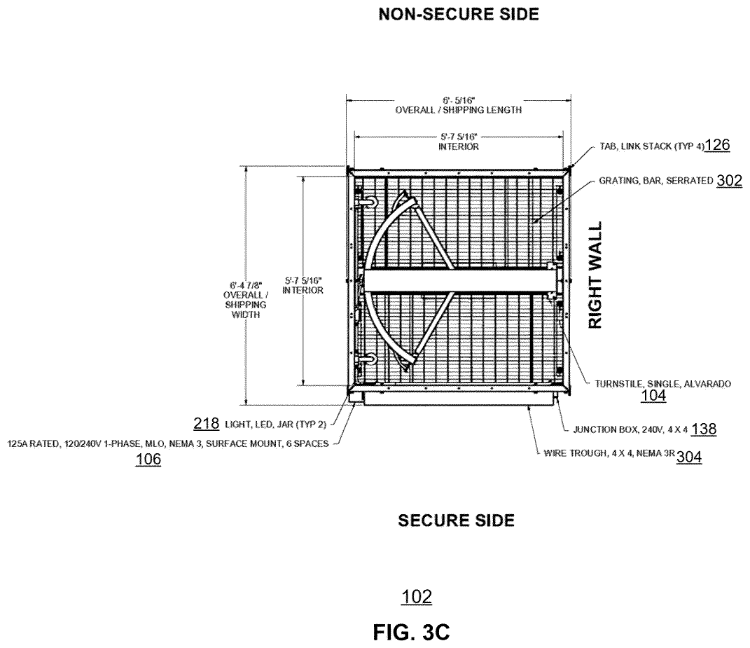

FIG. 3A illustrates an isometric view of a modular access control unit 102 with the roof removed to show internal components, based on the principles disclosed herein. The view is from the non-secure side, showing the structural enclosure and internal arrangement of components.

The structural enclosure comprises vertical wall panels mounted on a structural frame. The left wall and right wall are visible, along with the non-secure side wall at the front. The structural frame includes vertical structural members at the corners and horizontal structural members that provide support for the enclosure.

An access control door 104 is disposed within the structural enclosure, positioned centrally to control passage between the non-secure side and the secure side. In the illustrated embodiment, the access control door 104 comprises a turnstile mechanism with rotating arms that permit controlled passage of individuals through the unit.

Lighting 218 is disposed on the structural enclosure to provide illumination for the access control area. The lighting 218 comprises LED fixtures mounted on the interior surfaces of the enclosure.

The floor of the structural enclosure comprises grating that permits drainage and provides a non-slip walking surface. The grating is supported by the structural frame and spans the interior space of the modular access control unit 102.

FIG. 3B illustrates an isometric view of the modular access control unit 102 with the roof removed, showing the internal components and structural arrangement from the secure side perspective, based on the principles disclosed herein. The view provides a three-dimensional representation that reveals the interior configuration of the unit 102.

The structural enclosure includes vertical wall panels mounted on a structural frame, with a left wall, a right wall, and a non-secure wall visible in the view. The structural frame comprises vertical structural members positioned at the corners and horizontal structural members that provide support for the enclosure. The floor of the structural enclosure comprises grating that spans the interior space and is supported by the structural frame.

In the illustrated embodiment, the access control door 104 is disposed centrally within the structural enclosure, positioned to control passage between the non-secure side and the secure side. In the illustrated embodiment, the access control door 104 comprises a turnstile mechanism with vertical rotating arms that permit controlled passage of individuals through the unit.

An electrical panel 106 is disposed on the secure-side wall of the structural enclosure when viewed from the secure side. The electrical panel 106 is mounted on the exterior surface of the wall and is configured for power distribution within the modular access control unit 102.

A junction box 138 is disposed on the lower portion of the secure-side wall of the structural enclosure. The junction box 138 is positioned to provide electrical connection provisions for connecting to adjacent modular access control units 102 when multiple units are linked together.

FIG. 3C illustrates a top view of the modular access control unit 102, based on the principles disclosed herein. This view illustrates the different electrical connections within the modular access control unit 102. The modular access control unit 102 comprises a structural enclosure with vertical wall panels and a structural frame. In the illustrated embodiment, the access control door 104 is disposed centrally within the structural enclosure, positioned to control passage between the non-secure side and the secure side. In the illustrated embodiment, the access control door 104 comprises a turnstile mechanism with vertical rotating arms that permit controlled passage of individuals through the unit.

Grating bar 302 is disposed at the floor level of the structural enclosure. The grating bar 302 provides a walking surface that permits drainage and offers a non-slip surface for individuals passing through the modular access control unit 102. The grating bar 302 is supported by the structural frame and spans the width of the interior space.

Lighting 218 is disposed on the structural enclosure to provide illumination for the access control area. The lighting 218 comprises LED fixtures mounted on the interior surfaces of the enclosure, positioned to illuminate the access control door 104 and the surrounding area.

Tab 126 is disposed on the right wall of the structural enclosure when viewed from the secure side. The tab 126 comprises a mechanical connection provision configured to receive threaded fasteners for mechanical connection to an adjacent modular access control unit.

An electrical panel 106 is disposed on the secure-side wall of the structural enclosure. The electrical panel 106 is mounted on the exterior surface of the wall and is configured for power distribution within the modular access control unit 102. A junction box 138 is disposed on the lower portion of the right-portion of the secure-side wall of the structural enclosure. The junction box 138 is positioned to provide electrical connection provisions for connecting to adjacent modular access control units when multiple units are linked together. A wire trough 304 connects the wires between the electrical panel 106 and the junction box 138.

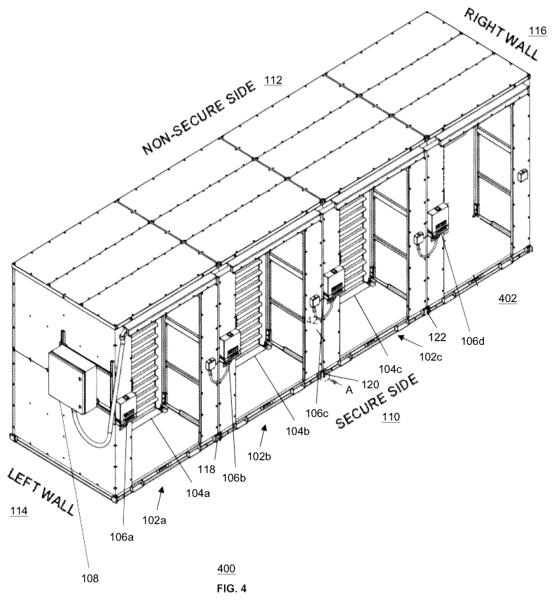

FIG. 4 illustrates an isometric view of a modular access control system 400 comprising multiple modular access control units 102 and a guard booth 402, based on the principles disclosed herein. The modular access control units 102 may be similar to those described with respect to FIGS. 1A-3C. FIG. 4 illustrates the principle that the guard booth 402 may replace one or more of the modular access control units 102 and uses the same mechanical, power and data connections discussed above. The guard booth 402 may contain any structure suitable for a guard, including e.g., one or more windows, control panels, and/or any equipment needed to view or communicate with the units 102 or outside world (i.e., Internet-enabled devices).

A number of implementations have been described. Nevertheless, it will be understood that various modifications may be made without departing from the spirit and scope of the disclosure. Accordingly, other implementations are within the scope of the following claims.

1. A modular access control system, comprising:
a plurality of modular access control units, each comprising:
an access control barrier disposed within a structural enclosure and configured to control passage from a non-secure side of the unit to a secure side of the unit;
a mechanical linkage configured to mechanically connect to an adjacent modular access control unit; and
an electrical connection configured to electrically connect to the adjacent modular access control unit.

2. The modular access control system of claim 1, wherein the access control barrier comprises a turnstile.

3. The modular access control system of claim 2, wherein the turnstile is a full-height turnstile.

4. The modular access control system of claim 1, wherein the mechanical linkage comprises one or more threaded connection tabs.

5. The modular access control system of claim 4, wherein the threaded connection tabs are configured to receive all-thread bolts for mechanical connection to the adjacent modular access control unit.

6. The modular access control system of claim 5, wherein the all-thread bolts are secured with nuts positioned on both sides of the mechanical connection.

7. The modular access control system of claim 1, wherein the electrical connection comprises an electrical panel disposed on the secure side.

8. The modular access control system of claim 7, wherein the electrical panel comprises a panel rated for 125 amperes at 120/240 volts single phase.

9. The modular access control system of claim 7, further comprising an exterior junction box disposed on the secure side and electrically connected to the electrical panel.

10. The modular access control system of claim 1, wherein each of the modular access control units comprises a data connection to communicate with other modular access control units.

11. The modular access control system of claim 1, further comprising a guard booth linked to one of the modular access control units.

12. A modular access control system, comprising:
a plurality of modular access control units positioned adjacent to each other, each modular access control unit comprising a structural enclosure and an access control barrier;
mechanical linking hardware connecting the plurality of modular access control units together, the mechanical linking hardware comprising threaded fasteners passing through aligned connection points on adjacent modular access control units; and
electrical connections between the plurality of modular access control units configured to distribute power from a single power source to multiple modular access control units.

13. The modular access control system of claim 12, wherein the access control barrier of each modular access control unit comprises a turnstile.

14. The modular access control system of claim 13, wherein each turnstile is a full-height turnstile.

15. The modular access control system of claim 12, wherein each of the modular access control units comprises a data connection to communicate with other modular access control units.

16. The modular access control system of claim 12, further comprising a modular guard booth.

17. A method of deploying a scalable access control system, comprising:
positioning a first modular access control unit at a desired location;
positioning a second modular access control unit adjacent to the first modular access control unit;
mechanically connecting the first modular access control unit to the second modular access control unit using connection hardware; and
electrically connecting the first modular access control unit to the second modular access control unit to enable power sharing.

18. The method of claim 17, wherein mechanically connecting the first modular access control unit to the second modular access control unit comprises inserting threaded fasteners through aligned connection tabs on both units.

19. The method of claim 18, wherein the threaded fasteners comprise all-thread bolts secured with jam nuts positioned on both sides of the connection.

20. The method of claim 17, wherein electrically connecting the first modular access control unit to the second modular access control unit comprises connecting a cable between electrical panels of the units.
